(19) United States
(12) Patent Application Publication
(10) Pub. No.: US 2008/0208780 A1
(43) Pub. Date: Aug. 28, 2008

(54) System and method for evaluating documents

(75) Inventors: John M. Hoopes, Washington, IL (US); Pauline C. Agbodjan-Prince, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/711,720

(22) Filed: Feb. 28, 2007

(51) Int. Cl. G06E 1/00

(52) U.S. Cl. 706/15

(57) ABSTRACT

A system for evaluating documents may include a memory location for storing one or more software modules, and a processor for executing the one or more software modules. The one or more software modules may be configured to perform a method. The method may include receiving a baseline record and a potentially matching record. The method may also include identifying baseline record data, and identifying potentially matching record data. The method may further include comparing the baseline record data with the potentially matching record data using matching criteria. The method may also include calculating a score for the potentially matching record based on rank values and weight factors associated with the matching criteria. The score may be a measure of similarity between the baseline record data and the potentially matching record data. The method may further include determining whether a match exists between the baseline record and the potentially matching record based on the score.

### TECHNICAL FIELD

The present disclosure relates generally to a system and method for evaluating, and relates more particularly to a system and method for evaluating documents.

### BACKGROUND

Systems for procuring products, including goods or services, often utilize documents to keep track of transactions. The documents may be transferred between entities, e.g., purchasers, suppliers, and/or receivers, as the goods are manufactured, purchased, shipped, received, used, and billed. Typical documents may include, for example, purchase orders, invoices, schedules, shipping notices, packing lists, and/or warehouse receipts, and are usually hardcopy paper documents. Additionally, such documents usually include a plurality of data such as, for example, product numbers, supplier names or numbers, product descriptions, quantities, delivery dates, and/or other data known in the art. Often, a document in a system may contain data which may not exactly match respective data of at least one other document of the same system. For example, an invoice indicating a certain quantity of products may not exactly match with a receipt. Unmatched documents must usually be evaluated and resolved before an accounts payable department pays a supplier. However, evaluating and resolving unmatched documents may cause a delay in payment to the supplier, require resources to resolve, and strain business relationships between suppliers and purchasers.

At least one system has been developed to evaluate and resolve unmatched documents. For example, U.S. Patent Application Publication No. 2003/0195836 to Hayes et al. (“Hayes '836”) discloses a method and system for approximate matching of data records. The method includes querying for a matching purchase order with respect to an invoice and, if a matching purchase order is found, automatically processing the purchase order and invoice. If a matching purchase order is not found, the method includes determining if a single best fit match is found and, if so, determining if the best fit match is within allowable thresholds. If the best fit match is within allowable thresholds, the invoice is automatically corrected to match the purchase order, and the documents are then automatically processed. If a single best fit match is not found or if the single best fit match is not within allowable thresholds, ranked approximate matches are sent to an operator for processing. However, identifying single best fit matches may cause problems where one-to-one matching between documents is not guaranteed. For example, if an invoice does not correspond to a single purchase order, but rather, corresponds to the sum total of multiple purchase orders, the system and method of Hayes '836 may only identify a single best fit match, possibly leaving the remaining purchase orders unmatched. The system in Hayes '836 may not provide a user with a simplified approach for calibrating and adjusting the system to help identify and match data records. Furthermore, the system in Hayes '836 automatically alters documents to create matches, which may produce errors if alterations are performed unnecessarily.

The system and method of the present disclosure is directed towards overcoming one or more of the constraints set forth above.

### SUMMARY OF THE INVENTION

In one aspect, the presently disclosed embodiments may be directed to a method for evaluating documents. The method may include receiving a baseline record and a potentially matching record. The method may also include identifying baseline record data, and identifying potentially matching record data. The method may further include comparing the baseline record with the potentially matching record by comparing the baseline record data with the potentially matching record data using matching criterion. The method may also include calculating a score for the potentially matching record based on rank values and weight factors associated with the matching criteria. The score may be a measure of similarity between the baseline record data and the potentially matching record data. The method may further include determining whether a match exists between the baseline record and the potentially matching record based on the score.

In another aspect, the presently disclosed embodiments may be directed to a method for evaluating documents. The method may include receiving a baseline record identifier and a potentially matching record identifier. The method may also include comparing the baseline record identifier with the potentially matching record identifier. Comparing the baseline record with the potentially matching record may include assigning a rank value based on the proximity of the potentially matching record identifier to the base record identifier, determining a score for the potentially matching record by multiplying a weight factor associated with the baseline record identifier and the potentially matching record identifier by the rank value, and determining whether a match exists between a baseline record and a potentially matching record based on the score.

In yet another aspect, the presently disclosed embodiments may be directed to a system for evaluating documents. The system may include a memory location for storing one or more software modules, and a processor for executing the one or more software modules. The one or more software modules may be configured to perform a method. The method may include receiving a baseline record and a potentially matching record. The method may also include identifying baseline record data, and identifying potentially matching record data. The method may further include comparing the baseline record with the potentially matching record by comparing the baseline record data with the potentially matching record data using matching criteria. The method may also include calculating a score for the potentially matching record based on rank values and weight factors associated with the matching criteria. The score may be a measure of similarity between the baseline record data and the potentially matching record data. The method may further include determining whether a match exists between the baseline record and the potentially matching record based on the score.

### BRIEF DESCRIPTION OF THE DRAWINGS

FIG. 1 is a schematic illustration of a system for evaluating documents, according to an exemplary embodiment of the present disclosure.

FIG. 2 is a flow diagram of a method for evaluating documents, according to an exemplary embodiment of the present disclosure.

FIG. 3 is an illustration of an electronic invoice record, according to an exemplary embodiment of the present disclosure.

FIG. 4 is an illustration of an electronic receipt record, according to an exemplary embodiment of the present disclosure.

FIG. 5 is an illustration of a data entry form according to an exemplary embodiment of the present disclosure.

FIG. 6 is an illustration of another data entry form according to an exemplary embodiment of the present disclosure.

FIG. 7 is an illustration of a summary form according to an exemplary embodiment of the present disclosure.

### DETAILED DESCRIPTION

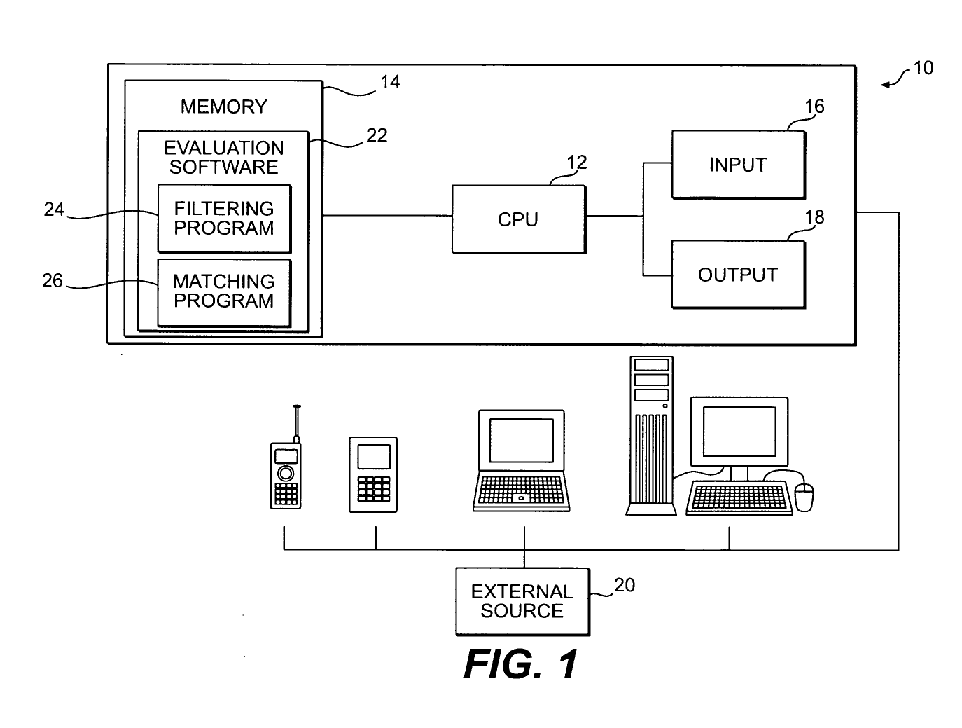

A system 10 for evaluating documents is shown in FIG. 1. System 10 may include one or more personal computers, laptops, personal digital assistants, or any other suitable computing devices. It is also contemplated that system 10 may be connected to a plurality of other computers through a network, including, for example, the Internet.

System 10 may include a central processing unit 12 (“CPU”), memory 14, input device 16, and output device 18. System 10 may also include other components in addition to or in place of those listed, as would be apparent to one skilled in the art. CPU 12 may be configured to execute software programs, including operating system software and/or application software. CPU 12 may include a microprocessor or any other suitable processing device. It is also contemplated that system 10 may include more than one CPU to enhance capacity and performance. Memory 14 may include one or more memory locations for storing software programs and other forms of data that may be accessed by CPU 12. The memory locations may be provided in the form of one or more hard disk drives, optical drives, flash memory devices, and or any other electronic storage media known in the art. Input device 16 may include a keyboard, mouse, stylus, and/or any other suitable device a user may use to enter data into system 10. It is also contemplated that input device 16 may include a data connection, configured to transfer data between system 10 and an external source 20, such as, for example, a remote computer system, server, mainframe, data repository, or any suitable data storage apparatus. Output device 18 may include a visual display, such as, for example, a screen or monitor. Output device 18 may also include a printer, audio equipment, and/or any other suitable device capable of communicating information to users.

Software executed by system 10 may include evaluation software 22. Evaluation software 22 may include one or more written programs, procedures, rules, and associated documentation, pertaining to operations of system 10. Evaluation software 22 may be stored in memory 14, or in a remote location accessible to system 10 through the Internet. Evaluation software 22 may include a filtering program or module 24 and a matching program or module 26.

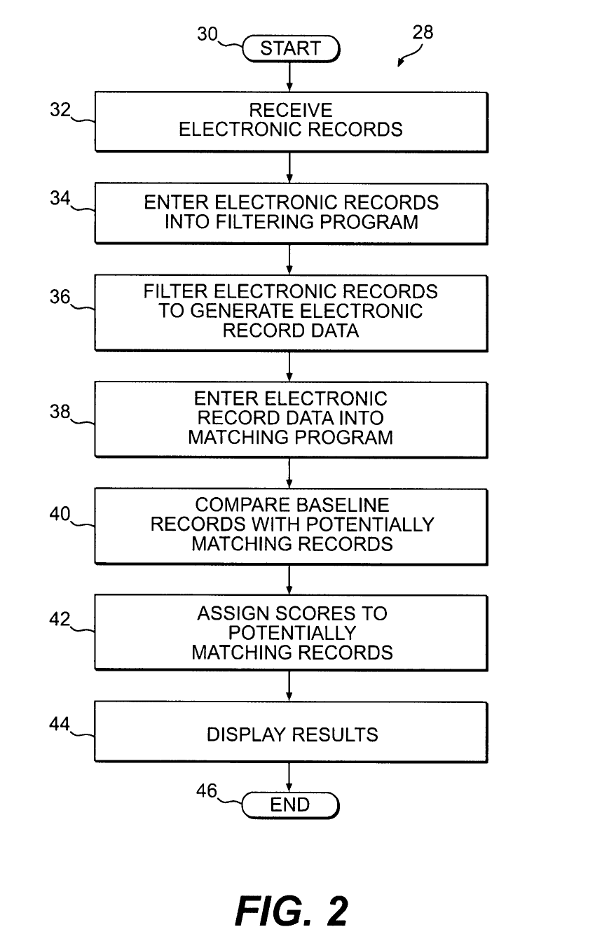

System 10 may be configured to perform a method 28, an embodiment of which is shown in FIG. 2. System 10 may start (step 30) performing method 28 automatically or at the prompting of a user. As an initial step, system 10 may receive electronic records (step 32). Each electronic record may contain data from a hard copy or an electronic copy of a document. The document may include spaces, lines, or locations where data may have been written or otherwise entered. The electronic record may be created by entering data from the document into fields in the electronic record. The fields may correspond to the spaces, lines, or locations on the document. The fields may be filled out manually using a keyboard, mouse, stylus, or any other suitable input device. The fields may also be filled out automatically. For example, optical character recognition technology, or any other suitable process for recognizing printed or written letters or numbers, may be used to scan the document for data. Data found during the scan may be automatically transferred into the fields of the electronic record.

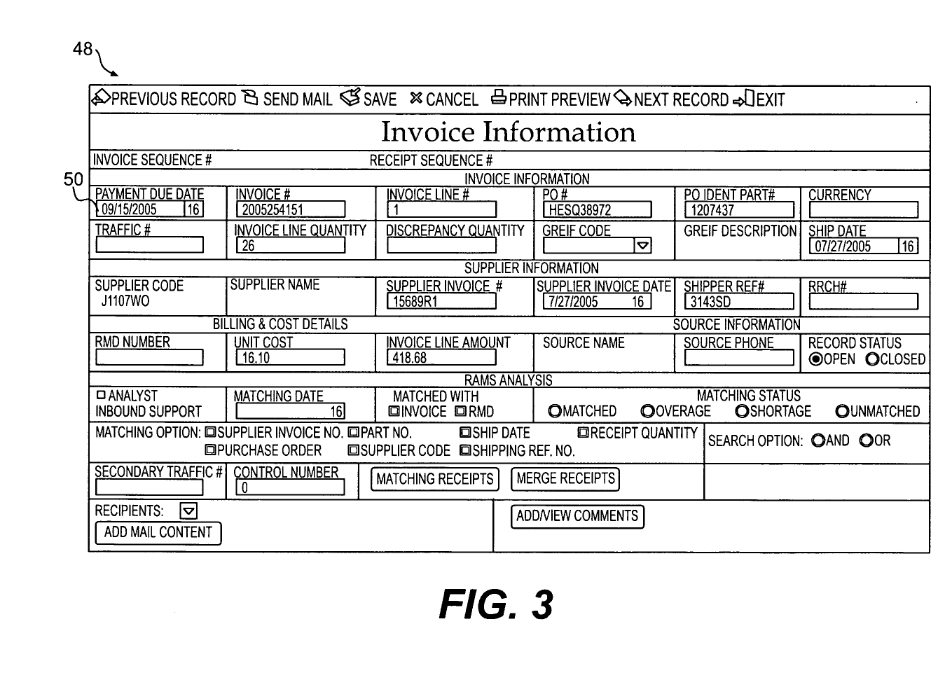

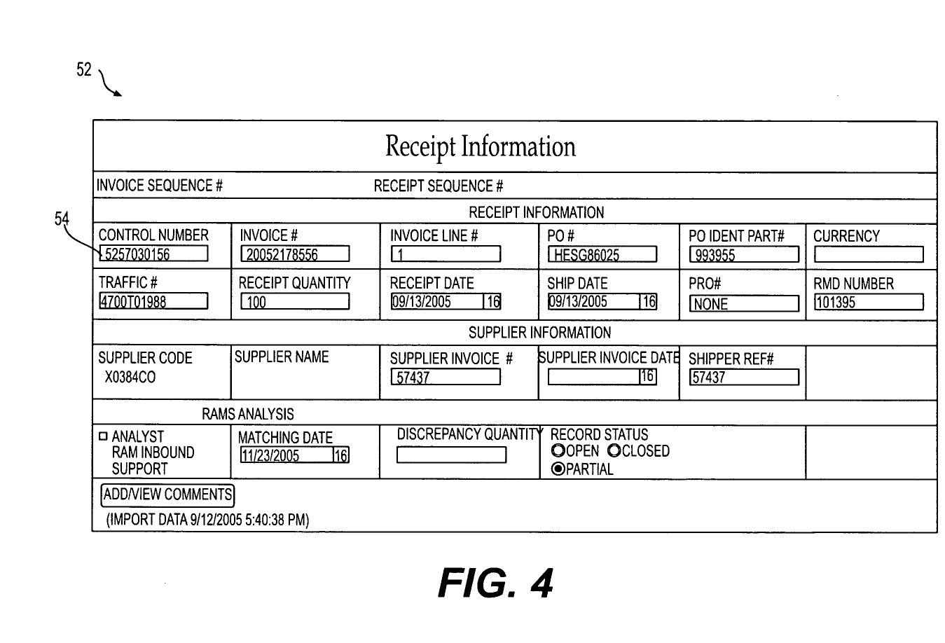

Electronic records may include, for example, invoices and receipts. An electronic invoice record 48, shown for example in FIG. 3, may include one or more fields 50 for receiving invoice data or identifiers, including, for example, payment due date, invoice number, invoice line number, part order number, part order identification number, currency, traffic number, invoice line quantity, discrepancy quantity, grief code, ship date, supplier invoice number, supplier invoice date, shipper reference number, unit cost, invoice amount, telephone number, and/or any other suitable fields that may be found on invoices. An electronic receipt record 52, shown for example in FIG. 4, may include one or more fields 54 for receiving receipt data or identifiers, including, for example, control number, invoice number, invoice line number, part order number, part order identification number, currency, traffic number, receipt quantity, receipt date, ship date, supplier invoice number, supplier invoice date, shipper reference number, and/or any other suitable fields that may be found on receipts.

While the discussion has thus far focused on electronic invoice records and electronic receipt records, it is also contemplated that electronic records may be generated for any other documents, depending on the characteristics of the business or industry with which system 10 is used. For example, electronic records may be created for purchase orders, schedules, shipping notices, packing lists, and/or reports.

Returning to the flow diagram of FIG. 2, the electronic records may be entered into filtering program 24 (step 34). Based at least in part on user-defined filtering criteria, filtering program 24 may analyze the electronic records, and may filter the data in the electronic records, thus identifying and retaining certain types of data for further analysis (step 36), while excluding other types of data.

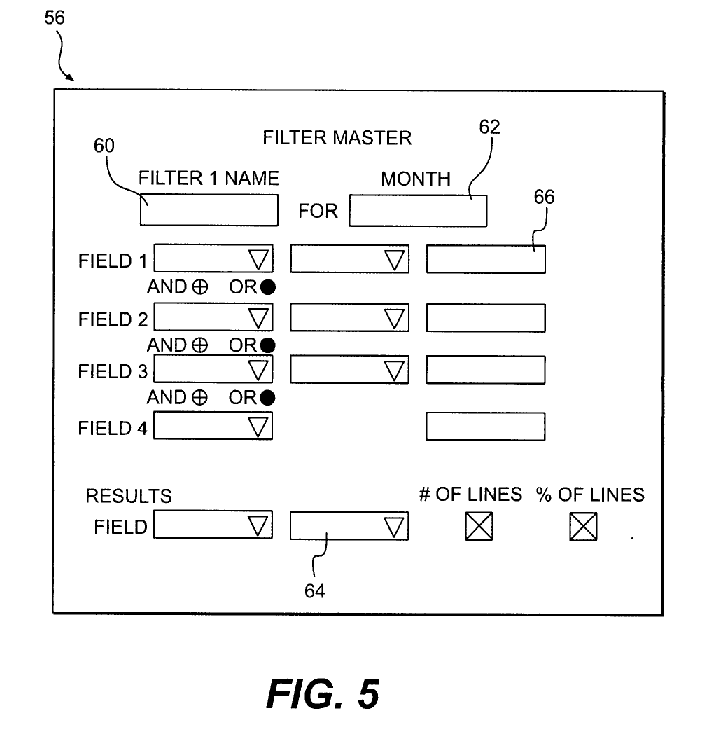

The accuracy of filtering program 24 in identifying data may be enhanced by using Boolean logic to focus on types of data containing specific combinations and variations of identifiers of interest to a user. For example, filtering program 24 may retain or exclude only that data in each electronic record that contains numerical values equal to, not equal to, greater than, greater than or equal to, less than, and/or less than or equal to, user-specified numerical values. Additionally or alternatively, filtering program 24 may retain or exclude only that data which may include character strings beginning with, not beginning with, ending with, not ending with, containing, or not containing, user-specified character strings. An exemplary embodiment of a filter master screen 56, where filtering criteria may be entered and selectively adjusted, is shown in FIG. 5. Filter master screen 56 may include one or more fields 66 in which users may enter identifiers and/or Boolean operators. Filter master screen 56 may also include a name field 60, month field 62, and one or more result fields 64. After a user enters identifiers, Boolean operators, and/or any other data into one or more fields 66, the user may elect to save those entries under a name and month by inputting the name into name field 60 and the month into month field 62, thus allowing the user to recall those entries at a later time. Results produced by executing filtering program 24 may be displayed in one or more result fields 64. For example, one or more result fields 64 may identify magnitude or percentage of data lines retained or excluded as a result of executing filtering program 24.

Returning again to the flow diagram of FIG. 2, the filtered data may be entered into matching program 26 (step 38). Matching program 26 may compare filtered data from the baseline records (“baseline record data”), with filtered data from the potentially matching records (“potentially matching record data”), in an attempt to find matches (step 40). For example, matching program 26 may match baseline record data from each baseline record against potentially matching record data of every potentially matching record, assigning an overall score, or weighted ranking value, to each of the potentially matching records (step 42). The overall scores may be indicative of the correctness of the attempted match between a particular baseline record and potentially matching records, in terms of the degree that the baseline record data and potentially matching record data fulfill matching criteria.

Matching criteria may include categories, such as, for example, part numbers, purchase order numbers, traffic numbers, supplier codes, supplier invoice numbers, shipping reference numbers, shipping dates, and/or receipt quantities. The categories may also cover any other type of identifier that may be found in the baseline records and the potentially matching records. Each category may be assigned a predetermined weight factor by, for example, a user of system 10. The weight factor may be indicative of the importance of the category to the matching process. The weight factor may be a percentage value, with more important categories being accorded higher percentage values than less important categories. In some configurations, weight factors may not exceed 100% when combined. The lowest weight factor may be 0%, which may have the effect of turning off a category for matching consideration.

Each category may have one or more rank values associated with it. For example, in one embodiment, a category may have six rank values, including, zero, one, two, three, four, and five. It should be understood that less, more, or different rank values may be used depending on the preferences of users. Each rank value may be associated with a number or range of numbers. When a baseline record is compared with a potentially matching record, a proximity value may be determined, the proximity value being indicative of the proximity of an identifier in the baseline record to an identifier in the potentially matching record. The proximity value may be compared to numbers or ranges associated with a category that encompasses the baseline record and potentially matching record identifiers. If the proximity value matches a number or falls within a particular range, the potentially matching record may receive the rank value associated with that number or range. This same methodology may be used to determine rank values for any other categories of identifiers that may be found on the baseline record and the potentially matching record.

For an identifier expressed as a date, ranges and proximity values may be expressed in increments of time. The increments of time may include spans of days, weeks, months, and/or years. For an identifier expressed as a quantity, ranges and proximity values may be expressed in units. The units may include units of product or hours of service. For an identifier expressed as a character string, ranges and proximity values may be expressed in terms of sequence and/or correctness. Sequence may refer to the order or arrangement of characters and/or the percentage of correct characters in the character string. Correctness may refer to the number of correct characters in a string of characters no matter what sequence they are in. The lower of the two may be applied for matching purposes.

It is also contemplated that ranges and proximity values may be expressed in terms of percentages. For example, the proximity of a first identifier to a second identifier may be expressed in terms of the percentage difference between the first identifier and the second identifier, using the second identifier as a baseline. A 0% proximity (e.g., a complete mismatch), may be associated with a rank value of zero. A proximity of 1% to 25% may be associated with a rank value of one. More specifically, when the proximity of the first identifier to the second identifier falls within 1% to 25%, a rank value of one will be assigned to the category describing those identifiers. A proximity of 26% to 50% may be associated with a rank value of two; 51% to 75% with a rank value of 3; 76% to 99% with a rank value of 4; and 100% with a rank value of 5. The ranges provided are exemplary only, and it should be understood that the ranges and their limits may be set at different points depending on the use for which system 10 is being employed.

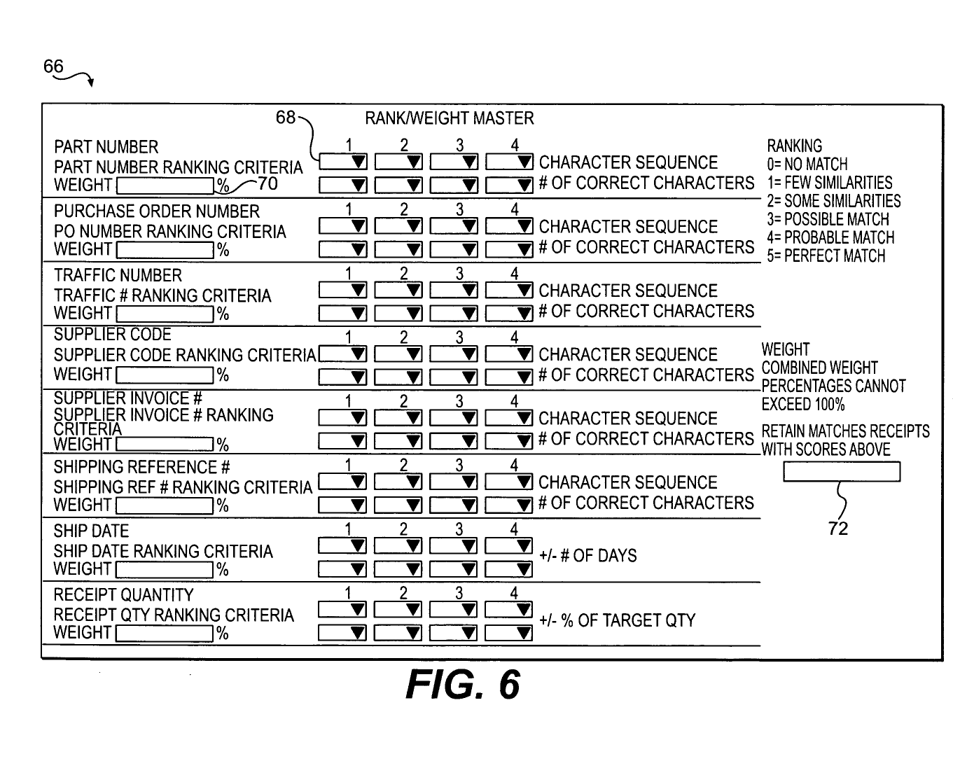

The overall scores may be calculated based on the rank values and predetermined weight factors. For example, calculating the overall score for a potentially matching record may involve calculating the product of the rank and weight factor for each of the categories in the potentially matching record, and then summing the products. If, for example, eight categories are used for matching comparison, as shown in FIG. 6, a formula may be used to calculate the score, where the score may equal

$${\sum }_{n = 1}^{k} ( {R}_{n} \times {W}_{n} ) ,$$

where k equals the total number of categories, and Rₙ and Wₙ correspond to the rank value and weight factor for each of those categories. Thus, for the record data shown, the score may equal (R₁×W₁)+(R₂×W₂)+(R₃×W₃)+(R₄×W₄)+(R₅×W₅)+(R₆×W₆)+(R₇×W₇)+(R₈×W₈). R₁ and W₁ may correspond to the rank value and weight factor for the part number category, and R₂ through R₈ and W₂ through W₈ may correspond to the rank values and weight factors, respectively, for the subsequent categories, including, for example, purchase order number, traffic number, supplier code, supplier invoice number, shipping reference number, ship date, and receipt quantity. A rank and weight master screen 58, where ranges may be set for rank values, and where weight factors may be entered, may be provided. For example, the part number category may in some instances be of key importance, and as such, may receive a higher weight factor than the receipt quantity category, which in some instances may be of lesser importance. Numbers or ranges may be entered in one or more fields 68, while weight factors may be entered into one or more fields 70. Rank and weight master screen 58 may also include a field 72, where users may enter threshold values for overall scores, such that only overall scores meeting or exceeding the threshold value may be retained. It is also contemplated that each potentially matching record may be automatically accepted as a match to a corresponding baseline record that it is compared against if the overall score meets or exceeds the acceptance threshold.

Each potentially matching record may include a tag line, header, labeling system, or other description to describe its score for each of the baseline records it is matched against. The description may be included in metadata that is tracked and updated by filtering program 24 and/or matching program 26 for each potentially matching record.

Whenever a match is made between a particular baseline record and one or more potentially matching records, those matched records may be made unavailable for further matching. In other words, once the baseline record has accepted a match, remaining potentially matching records may not be required to keep score for that baselines record. Similarly, once potentially matching records are matched with baseline records, those potentially matching records may no longer be eligible for matching. This may cut down on processing time by decreasing the number of records that matching program 26 has to consider. It is also contemplated that after matching program 26 has executed, matched records may be directed to one or more memory locations with other matched records, and unmatched records may be directed to one or more memory locations with other similar unmatched records. The unmatched records may be reprocessed using filtering program 24 and/or matching program 26. Additionally or alternatively, the unmatched records may be sent to one or more analysts for further analysis. The analysts may determine if any matches can be made. If matches cannot be made, system 10 may automatically send an electronic communication, such as, for example, an e-mail, instant message, or any other suitable form of electronic communication, to one or more parties, including analysts, employees, or supervisors. The analysts may provide comments in a comments section associated with a record describing why a match cannot be found for the record, leaving the record data as is. Additionally or alternatively, the analysts may match otherwise unmatching records, explaining the reasons for such a match in the comments section.

In one embodiment, as yet unmatched electronic invoice records and electronic receipt records that may match in certain aspects, but not in quantity, may be directed to a memory location (e.g., memory 14). Matching program 26 may aggregate a plurality of unmatched electronic receipt records to match the quantity of an unmatched electronic invoice record. Thus, matching program 26 may be capable of matching records even if multiple receipts are received for a single invoice. For example, suppose an order is placed for 100 parts. If a single invoice record is found listing the 100 parts corresponding to the order, and four receipts are found corresponding to the order, but having twenty-five parts listed on each, then matching program 26 may aggregate the four receipts into a match for the single invoice record. If, however, a match still cannot be found, an electronic communication may automatically be sent to the appropriate parties for resolution, as discussed above.

Matching program 26 may determine whether to aggregate records to produce a match. If, for example, a match exists between a baseline record identifier of a baseline record and an identifier in each of a plurality of potentially matching records, matching program 26 may recognize a correspondence between the baseline record and each of the plurality of potentially matching records. If the category for the identifiers is one assigned with a high predetermined weight factor, the correspondence may be viewed by matching program 26 as being strong. If a match cannot be made for the remaining baseline record identifiers and the remaining potentially matching record identifiers in categories having lower predetermined weight factors, matching program 26 may check the plurality of potentially matching records to determine if the unmatched identifiers can be matched by aggregation. Thus, if a key identifier (i.e., one having a high weight factor) in a baseline record matches with a key identifier in each of a plurality of potentially matching records, matching program 26 may seek to aggregate the plurality of potentially matching records to determine whether aggregation produces a match between less important identifiers (i.e., those having lower weight factors) in the baseline record and the plurality of potentially matching records. Additionally or alternatively, if the aggregated records do not exceed the predetermined matching threshold, system 10 may send an electronic notification to a user, including, for example, an alert, instant message, e-mail, and/or any other suitable electronic notification. The electronic notification may contain information pertaining to the potentially matching records in the aggregate.

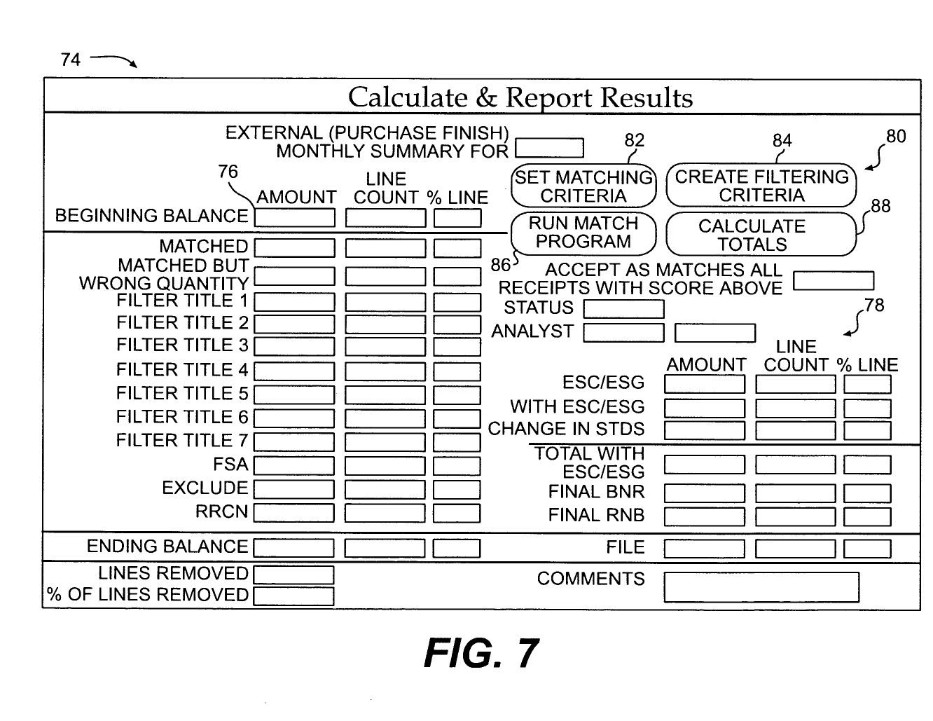

Results produced by matching program 26 may be displayed to the user on a summary form 74 (step 44), such as that shown in FIG. 7, at which point the method may end (step 46). Summary form 74 may include a plurality of fields, including, for example, one or more result fields 76 configured to receive and/or display results from matching program 26 and/or filtering program 24. Results may be reported in terms of dollar amounts, number of lines of data, and/or percentage of lines of data. One or more additional information fields 78, configured to receive and display other information that may be useful to the user, such as, for example, the month being analyzed, threshold score requirements, status, name of analyst, number or percentage of electronic records removed, and comments, may also be provided. Summary form 74 may also include a menu 80 having one or more menu items. Some menu items may include, for example, a set matching criteria option 82, a create filtering criteria option 84, a run match program option 86, and a calculate totals option 88. Selecting create filtering criteria option 84 may open or otherwise direct the user to filter master screen of FIG. 5, allowing the user to change filtering criteria used by filtering program 24. Selecting set matching criteria option 82 may open or otherwise direct the user to rank and weight master screen of FIG. 6, allowing the user to change matching criteria used by matching program 26. Selecting run match program option 86 may trigger execution of matching program 26, thus allowing the process to be repeated. Selecting calculate totals option 88 may trigger the calculation of totals that may be displayed in one or more additional information fields 78 of summary form 74 of FIG. 7. It is contemplated that summary form 74 may present daily or annual totals, or totals for any other period of time specified by a user.

### INDUSTRIAL APPLICABILITY

The disclosed system 10 for evaluating documents may have applicability in business organizations that send and receive documents. Documents may include, for example, purchase orders, invoices, schedules, shipping notices, packing lists, and/or warehouse receipts.

Business organizations may spend time and money matching documents for record keeping purposes. For example, business organizations may match invoices and receipts to balance their records. Unmatched receipts may be interpreted as indicating that goods or services have been received by a business organization, but have not yet been paid for by the business organization. Unmatched invoices may be interpreted as indicating that goods or services have been paid for by the business organization that either do not have corresponding receipts, or have corresponding parts or material that were lost. As a result of these discrepancies, perceived debt may be artificially inflated, possibly leaving business organizations with less working capital. System 10 may match invoices to receipts that would most likely not have been matched using manual methods, thus reducing the number of unmatched invoices and receipts, resulting in more accurate debt determinations and corresponding increases in working capital.

System 10 may also include a filtering program 24 that may provide system 10 with the ability to receive and process data, arriving in different formats or from different sources, and may identify data for analysis. Moreover, system 10 may provide users with the ability to change filtering criteria to shift the focus from one type or kind of data element to another. Thus, system 10 may be more robust, as it may be applied in virtually any business environment.

Moreover, instead of just providing choices for users to consider as potential matches, system 10 may provide a method of prioritizing the best possible selections by ranking and weighing the possible matches in terms of correctness. For example, if the part number is a category being used for matching consideration, the part number may have one or more rank values associated with it, such as, for example, zero through five. For a five digit part number, the rank values may correspond to the number of matching digits between the part number identifier on the baseline record, and the part number identifier on the potentially matching record. If the matching program 26 determines that all 5 of the digits of the part number identifiers match, then a rank value of 5 may be assigned. For exemplary purposes only, suppose that the part number identifier on the baseline record is 12345, while the part number identifier on the potentially matching record is 12367. Only three numbers match, corresponding to a rank value of 3. Matching program 26 may multiply the weight factor assigned to the part number category, which may be 20% for example, by the rank value of 3, producing a score of 60 for the part number category. The weight factor may include a predetermined factor set by a user that indicates the importance of a category to the matching process. Those categories of greater importance may be assigned a higher weight factor, while those of lesser importance may be assigned a lower weight factor. The same or similar analysis may be carried out for each of the other categories, and all of the values may be plugged into the formula

$${\sum }_{n = 1}^{k} ( {R}_{n} \times {W}_{n} ) ,$$

where k equals the total number of categories, and Rₙ and Wₙ correspond to the rank value and weight factor for each of those categories. When all of the rank values and weight factors have been determined, matching program 26 may calculate the overall score for the match between the baseline record and the potentially matching record using the formula.

System 10 may also provide users with the ability to automatically accept matches based on rank and weight scores. Further, system 10 may provide users with the ability to adjust the ranking and weighing criteria to “fine tune” the process and the results. Moreover, system 10 may provide users with the ability to set threshold scores. A threshold score may be set such that scores below the threshold will not be tracked. An other or additional threshold score may be set such that upon meeting or exceeding the threshold score, system 10 will automatically determine that a match exists between the records being compared. It is also contemplated that, for example, if only one potentially matching record produces a high overall score when compared to a baseline record, and all the other potentially matching records produce overall scores that are less than a threshold value, system 10 may automatically match the potentially matching record producing the high overall score to the corresponding baseline record.

It will be apparent to those skilled in the art that various modifications and variations can be made in the disclosed system and method without departing from the scope of the disclosure. Additionally, other embodiments of the disclosed system and method will be apparent to those skilled in the art from consideration of the specification. It is intended that the specification and examples be considered as exemplary only, with a true scope of the disclosure being indicated by the following claims and their equivalents.

What is claimed is:

1. A method for evaluating documents, comprising:
receiving a baseline record and a potentially matching record;
identifying baseline record data;
identifying potentially matching record data;
comparing the baseline record data with the potentially matching record data using matching criteria;
calculating a score for the potentially matching record based on rank values and weight factors associated with the matching criteria;
wherein the score is a measure of similarity between the baseline record data and the potentially matching record data; and
determining whether a match exists between the baseline record and the potentially matching record based on the score.

2. The method of claim 1, wherein the score is stored with the potentially matching record.

3. The method of claim 1, wherein the score is only stored with the potentially matching record if the score satisfies an acceptance threshold.

4. The method of claim 1, wherein a match exists if the score satisfies a matching threshold.

5. The method of claim 1, wherein when a match exists, the potentially matching record becomes ineligible for comparison with other baseline records, and the baseline record becomes ineligible for comparison with other potentially matching records.

6. The method of claim 1, wherein the baseline record is an invoice and the potentially matching record is a receipt.

7. The method of claim 1, further including aggregating the potentially matching record data from a plurality of potentially matching records to match the baseline record data.

8. The method of claim 1, wherein the matching criteria includes a plurality of identifier categories, and the score equals:
$${\sum }_{n = 1}^{k} ( {R}_{n} \times {W}_{n} ) ;$$
wherein k is the total number of identifier categories, Rₙ is a rank value associated with an identifier category, and Wₙ is a weight factor associated with the identifier category.

9. A method for evaluating documents, comprising:
receiving a baseline record identifier and a potentially matching record identifier; and
comparing the baseline record identifier with the potentially matching record identifier;
wherein comparing the baseline record identifier with the potentially matching record identifier includes:
assigning a rank value based on the proximity of the potentially matching record identifier to the baseline record identifier;
determining a score for the potentially matching record identifier by multiplying a weight factor associated with the baseline record identifier and the potentially matching record identifier by the rank value; and
determining whether a match exists between a baseline record and a potentially matching record based on the score.

10. The method of claim 9, further including aggregating a plurality of potentially matching record identifiers to match the baseline record identifier.

11. The method of claim 10, further including automatically sending an electronic notification when a match cannot be made.

12. The method of claim 9, further including automatically matching the baseline record and the potentially matching record if the score exceeds a matching threshold.

13. The method of claim 9, wherein the weight factor is indicative of the importance of the baseline record identifier and the potentially matching record identifier in determining whether a match exists between the baseline record and the potentially matching record.

14. The method of claim 9, wherein when a match exists, the potentially matching record becomes ineligible for comparison with other baseline records, and the baseline record becomes ineligible for comparison with other potentially matching records.

15. The method of claim 9, wherein the baseline record is an invoice and the potentially matching record is a receipt.

16. A system for evaluating documents, comprising:
a memory location for storing one or more software modules; and
a processor for executing the one or more software modules;
wherein the one or more software modules is configured to perform a method, the method comprising:
receiving a baseline record and a potentially matching record;
identifying baseline record data;
identifying potentially matching record data;
comparing the baseline record data with the potentially matching record data using matching criteria;
calculating a score for the potentially matching record based on rank values and weight factors associated with the matching criteria;
wherein the score is a measure of similarity between the baseline record data and the potentially matching record data; and
determining whether a match exists between the baseline record and the potentially matching record based on the score.

17. The system of claim 16, wherein the one or more software modules includes a filtering module.

18. The system of claim 17, wherein the filtering module is configured to filter the baseline records and the potentially matching records.

19. The system of claim 16, wherein the one or more software modules includes a matching module.

20. The system of claim 16, wherein when a match exists, the matching module renders the potentially matching record ineligible for comparison with other baseline records, and the baseline record ineligible for comparison with other potentially matching records.

21. The system of claim 16, wherein the method further includes aggregating the potentially matching record data from a plurality of potentially matching records to match the baseline record data.

22. The system of claim 16, wherein the matching criteria includes a plurality of identifier categories, and the score equals
$${\sum }_{n = 1}^{k} ( {R}_{n} \times {W}_{n} ) ;$$
wherein k is the total number of identifier categories, Rₙ is a rank value associated with an identifier category, and Wₙ is a weight factor associated with the identifier category.
